(19) United States
(12) Patent Application Publication
(10) Pub. No.: US 2022/0098489 A1
(43) Pub. Date: Mar. 31, 2022

(54) METHOD OF IMPROVING THE FIRE RESISTANCE OF A CELLULOSE MATERIAL

(71) Applicant: Woodholdings Environmental, Inc., Scottsdale, AZ (US)

(72) Inventors: Edwin Neal, Phoenix, AZ (US); Robert William Morton, Bartlesville, OK (US); Fred Donald Lowder, Amarillo, TX (US)

(21) Appl. No.: 17/486,786

(22) Filed: Sep. 27, 2021

Related U.S. Application Data
(60) Provisional application No. 63/083,289, filed on Sep. 25, 2020.

(51) Int. Cl. C09K 21/02; D21H 21/34; D21H 17/66; D21H 23/04; B27K 3/16; B27K 3/18

(52) U.S. Cl. CPC C09K 21/02; D21H 21/34; D21H 17/66; B27K 2240/30; B27K 3/163; B27K 3/18; D21H 23/04

(57) ABSTRACT

A method for improving the fire resistance of a cellulose material comprises mixing boric acid with methanol to form a boric acid ester, combining the borate ester with magnesium sulfate to form a low viscosity magnesium borate sulfate solution, treating the cellulose material with the magnesium borate sulfate solution, and heating the treated cellulose material to evaporate remaining alcohol and solvent to form a crystals of a complex mixture containing combinations of magnesium sulfate, boric acid, magnesium borate, magnesium borate sulfate and their hydrates.

### CROSS-REFERENCE TO RELATED APPLICATIONS

This application claims the benefit of U.S. Provisional Application No. 63/083,289 filed Sep. 25, 2020.

### BACKGROUND

### Technical Field

The present invention relates generally to improving the fire resistance of a cellulose material and more particularly relates to a process of treating cellulose and wood with borate compounds and forming products therefrom.

### Description of Related Art

Boric acid has been used to treat wood to improve its resistance to flame and fire. However, boric acid is not very soluble in water, which has limited the extent to which it can penetrate wood and cellulose, and how much boric acid can be introduced. Additionally, solutions of sodium borate employed to make fire resistant cellulose are caustic limiting the context in which they are applied. For example, such a caustic material would not be appropriate for use as a fire retardant in airplanes.

### SUMMARY OF THE INVENTION

A method for improving the fire resistance of a cellulose material comprises mixing boric acid with methanol to form a boric acid ester, combining the borate ester with magnesium sulfate to form a low viscosity magnesium borate sulfate solution, treating the cellulose material with the magnesium borate sulfate solution, and heating the treated cellulose material to evaporate remaining alcohol and solvent to form borate crystals within the cellulose material.

### BRIEF DESCRIPTION OF THE DRAWINGS

FIG. 1 is a high level schematic diagram of the process of improving the fire resistance of a cellulose material according to the invention.

FIG. 2 is schematic diagram of the process of combining borate ester with a salt solution.

FIG. 3 is a schematic diagram of the process of combining a borate ester with a salt solution to create a boron compound.

FIG. 4 is a schematic diagram of the process of treating cellulose fibers using a boron compound.

FIG. 5 is a schematic diagram of the process of treating cellulose fibers using a magnesium borate sulfate solution.

### DETAILED DESCRIPTION OF THE ILLUSTRATED EMBODIMENT

Overview

Contemplated herein is a process for treating cellulose and wood with borate compounds, as well as the process for forming said compounds. Specifically, this process for the impregnation of cellulose and wood with boric acid or boron oxide comprises the application thereto of boric acid esters of alcohols and thereafter hydrolyzing the esters to deposit boric acid within the wood or cellulose product.

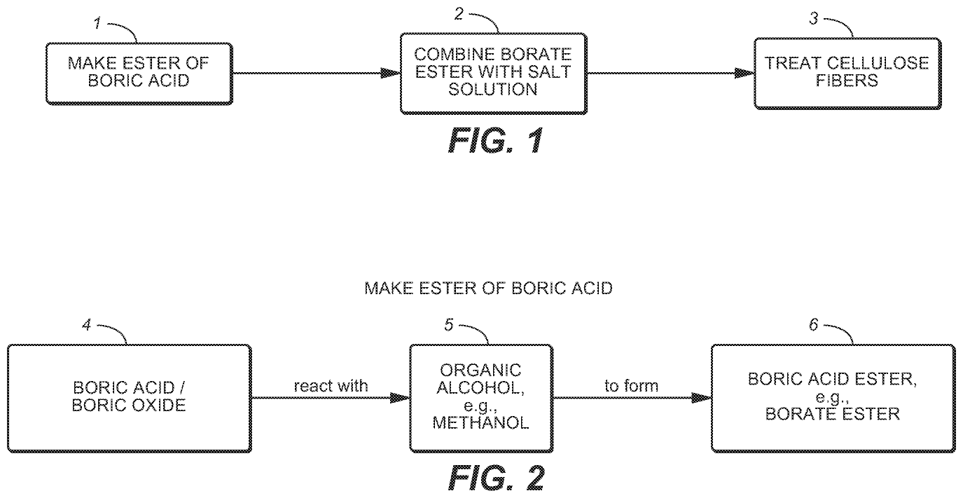

The contemplated process and borate compounds are advantageous over conventional methods for a number of reasons. Unlike boric acid, the boron compounds disclosed herein are extremely water soluble. With reference to FIG. 1, the boron compounds are formed by creating an ester of boric acid, at 1, as an intermediary, and then combining the borate ester with a salt solution, at 2, resulting in a compound for treating cellulose fibers, at 3. Additionally, the solutions of this borate salt are not alkaline, making them easy to prepare and safe to handle. According to various embodiments, the contemplated boron compounds are pH neutral, or close to it after adjusting the pH with a neutralizing compound, e.g., ammonium hydroxide, expanding the contexts in which they can be used. Furthermore, the resulting compound is low viscosity, improving penetration and expanding the ways it may be applied to materials. For example, in some embodiments, the compound may be applied using a sprayer.

In the context of the present description, a fire retardant is a substance that is used to slow down or stop the spread of fire or reduce its intensity. Similarly, a flame retardant is a substance that prevents or slows the further development of ignition.

Many of the drawbacks of conventional methods for using boric acid to improve the fire resistance of wood and cellulose stem from its low solubility in water. Contemplated herein is a process for making boron compounds that are highly soluble in water. First, the boric acid or boron oxide is reacted with an organic alcohol to form, at least in part, a boric acid ester. This boric acid ester may contain, dissolved therein, additional boric acid.

While much of the following discussion will be had in the context of a non-limiting example of a borate ester formed with methanol, as shown in FIG. 2, it should be noted that according to various embodiments, the borate ester 4 can be produced from boric acid or boron oxide and any of the organic alcohols 5. These organic alcohols include, but are not limited to, methanol, ethanol, 1-propanol, 2-propanol, glycerol, ethylene glycol, propylene glycol, isopropanol, similar mono and dialiphatic alcohols, polyethylene glycol, and the like. Boric acid can form esters 6 with such alcohols in proportions of 1, 2 and 3 moles of alcohol per mole of boric acid, or any combination between 1 and 3 moles of alcohol per mole of boric acid. By appropriately selecting the quantities of alcohol and boric acid, the times and temperatures of the esterification reaction and the amount of water removed therefrom, it is possible to control the amount of esterification so that mono-, di- and/or triesters of boric acid can be obtained or mixtures thereof.

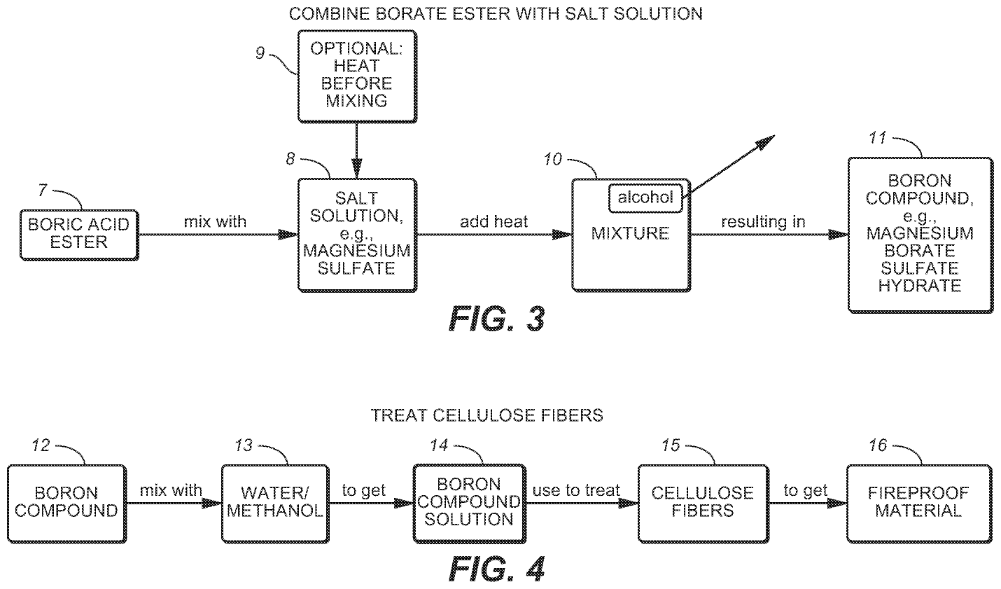

Next, with reference to FIG. 3, the boric acid ester 7 is combined with a salt solution 8. The salt or salts aid in the dissolution of the borate esters, as well as the penetration of the borate deep into the cellulose or wood material. It should be noted that while much of the following discussion will be in the context of a non-limiting example of magnesium sulfate, which is cheap and readily available, other salts may be used. According to various embodiments, the salt solution may comprise salts of magnesium, calcium, sodium, potassium, ammonium, aluminum, zinc, iron, and/or other cations, in conjunction with phosphate, carbonate, bicarbonate, silicate, sulfate, hydroxide, chloride, and nitrate counter ions. In some embodiments, a single salt may be used, while in other embodiments, more than one salt may be used. In some embodiments, the salt solution may be heated, at 9, before being combined with the boric acid ester. The hot salt solution promotes the hydrolysis of the borates.

According to some embodiments, after the salt solution and the borate ester have been combined, the mixture is heated, at 10, to remove the alcohol. In some embodiments, the alcohol may be reclaimed through condensation. The result is a solid 11 that is highly soluble in water.

With reference to FIG. 4, treatment of cellulose fibers is performed by mixing the boron compound, at 12, with water, at 13, or methanol, to convert it to a low viscosity liquid, at 14, which can then be used to treat cellulose fibers, at 15, resulting in a fireproof material, at 16. The pH of a saturated solution with water is around 6, making the solution much easier and safer to work with than conventional boric acid compounds.

According to various embodiments, the resulting solid, and the reconstituted compound, is a hydrate. This is advantageous for fire retardant application. Conventional retardant compounds that are sprayed or dumped over large areas typically lose efficacy once their water is evaporated. The contemplated compounds, which may be higher order hydrates (e.g., decahydrates), have chemically bound water, which requires additional energy to release it. This may serve to prevent the reignition of burnt or charred materials, as the trapped water is released by the embers.

Interestingly, not only is this compound highly soluble in water, in some embodiments it is also soluble in alcohol, e.g., methanol, allowing the dissociated anion to vary as B(OH)ₓ(OCH₃)_{y}, with x+y being 3. According to various embodiments, the ratio of hydroxyl groups to methoxy groups may be chosen to tailor the solution to a particular application. Various applications of the contemplated compounds will be discussed below, preferring solutions of water, methanol, or a mixture.

Magnesium Borate Sulfate Hydrate

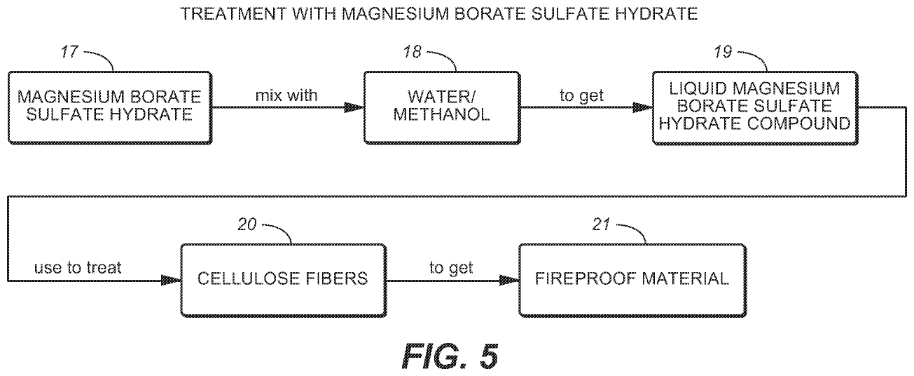

The use of the term magnesium borate sulfate hydrate according to the invention is understood to indicate a treatment of a cellulose material with a complex mixture containing combinations of magnesium sulfate, boric acid, magnesium borate, magnesium borate sulfate and their hydrates. In one embodiment of the invention, and with reference to FIG. 5, boric acid may be combined with methanol to form a borate ester. This borate ester may then be combined with a heated magnesium sulfate salt solution. After the water and methanol have been removed, the resulting solid is a mixture containing combinations of magnesium sulfate, boric acid, magnesium borate, magnesium borate sulfate and their hydrates 17. This solid may be reconstituted, at 18, into low viscosity liquid, at 19, using water, methanol, or a mixture of water and alcohol. Advantageously, the same magnesium borate sulfate hydrate solid may be turned into different solutions tailored for different applications.

The resulting borate hydrate compound may be applied to wood or cellulose, at 20, resulting in a fireproof material, at 21. According to various embodiments, this borate compound has a low viscosity, allowing it to penetrate deep and introduce boric acid or boron oxide into the cellulose or wood material thus locking the borate compounds in and establishing a fireproof product. It should be noted that while the following discussion will be had in the context of application to wood, the processes discussed are also applicable to other cellulose materials as well.

In some embodiments, the wood may be dried before application of the borate compound, while in other embodiments, the application may be immediately performed. The wood may be heated to facilitate application. For example, in one embodiment, the application may be performed at a temperature between 50° F. and 120° F. The mixture is allowed to be absorbed by the cellulose or wood material. Any remaining volatile alcohol or solvent evaporates, and further hydrolyzes the boric acid ester with insipient moisture to boric acid or boron oxide. Once absorbed, crystals slowly form around the cellulose or wood fibers producing a fireproof material. These crystals may be a complex between the boric acid and the cation of the salt. For example, the application of a magnesium borate sulfate hydrate solution may result in crystals of containing combinations of magnesium sulfate, boric acid, magnesium borate, magnesium borate sulfate and their hydrates.

Applications

Cellulosic Materials

The borate compound may be applied to OSB or engineered lumber as well. For example, in some embodiments, wood chips may be soaked or sprayed with the borate compound in a hopper, as the chips are turning or agitated. These treated chips are then turned into the engineered lumber or OSB.

In some embodiments, the borate compound may be combined with water, while in other compounds, the borate compound may be formed using methanol (or other alcohol) or a mixture of methanol and water. Each has advantages. The solutions comprising methanol may better penetrate the wood or cellulose, while the water-based borate compound may facilitate the deposition of a higher concentration of boric acid or boron oxide towards the surface of the treated wood material.

In some embodiments, the wood or cellulose material may be treated with a single application of the borate compound. In other embodiments, the material may be treated with multiple applications, which may allow better penetration and/or higher concentration. For example, in some embodiments, the solution may be applied at a concentration of 10% by weight to saturation. The same effect may be achieved with multiple applications with a solution whose concentration is less than 10% by weight to saturation.

In some embodiments, the borate compound may be applied as different solutions to achieve a better penetration at a higher concentration. As a specific, non-limiting example, a low concentration first application, which penetrates deep because of a lower viscosity. For example, the first coat may be 2.9 parts methanol, 0.1 part water. The second coat may have a higher concentration of the salt, enriching the material closer to the surface. For example, the second coat may be 0.1 parts methanol and 2.9 parts water.

After the borate compound has been applied to the wood or cellulose material, the hydrolysis/evaporation of the compound within the material may be driven by heating the material. For example, in one embodiment, the material may be heated to 250° F., while in others it may be heated to higher or lower temperatures. In other embodiments, the treated wood or cellulose material may be simply allowed to air dry.

Types of cellulose materials that can benefit from treatment with the contemplated compounds include, but are not limited to, sawn timber, logs, glulam (glued laminated lumber), dimensional lumber, plywood, laminated veneer lumber (LVL), wood based composite products such as oriented strand board (OSB) and wood chips for making the same, medium density fiberboard (MDF) and wood fibers for making the same, fiberboard, hardboard and particle board. Other cellulose or cellulosic materials that can benefit from treatment with the contemplated compounds are lignocellulosic substrates, wood plastic composites, cardboard and cardboard faced building products such as plasterboard, and cellulosic material such as cotton. Also rice fiber as well as other fiber from both endogenous and exogenous sources, as well as paper, cardstock, cardboard, or the like. For convenience, the present disclosure provides a description with reference to the treatment of cellulose material, but it will be appreciated that all of the above and other cellulosic materials may be treated analogously, and for ease of description are referred to herein as “cellulose material.” In one aspect, the cellulose material comprises wood pieces used to produce a wood based composite product, including OSB and MDF.

Non-Wood Applications

As previously mentioned, the contemplated borate compounds have applications beyond the treatment of wood and cellulose materials. The contemplated borate compounds may be formed as solutions having a near neutral pH, as well as low viscosity. Exemplary applications include, but are not limited to, sprayable fire retardant, insecticide, and creation of deicing materials, each of which will be briefly discussed, below.

The contemplated borate compound may be formed using water and sprayed or dumped on wood and other materials in anticipation of an approaching fire, such as a forest fire. The contemplated compounds have a depressed freezing point, allowing them to be used in conditions below 32° F. As long as the solution is liquid and flowable, it will be absorbed by cellulose and wood. They may be sprayed as a mist or applied similar to other liquid fire retardants. Advantageously, in some embodiments, the borate compound may be formed using nitrates, such as ammonium nitrate, which may serve as a fertilizer to facilitate regrowth after the fire has passed.

The contemplated compounds may be advantageous over other conventional fire retardants, which are ineffective once their water is gone. The contemplated compounds leave behind an inorganic salt that treats dead brush, inhibiting reignition. In some embodiments, phosphate salts may be preferred over sulfates for application as a sprayed fire retardant. As a specific example, in one embodiment, the salt may comprise sodium dihydrogen phosphate or disodium hydrogen phosphate.

Boric acid has been used conventionally as an insecticide, effective against various insects including but not limited to ants, fire ants, chiggers, and the like. The contemplated borate compounds may be used as insecticide, which is advantageous over conventional applications of boric acid since the pH of the solution is neutral or near neutral yet is easily applied as a sprayable liquid. In some embodiments, the solution of borate compound may be made with methanol. The methoxy decomposes with moisture in the ground forming boric acid which inhibits insect infestations.

The contemplated borate compounds have a depressed freezing point, allowing them to be applied to wood or cellulose material to create deicing materials. For example, the compound may be applied to sawdust or small chunks of wood and placed on sidewalks or roadways similar to sodium or calcium chloride. As an option, a nitrate may be incorporated to act as a fertilizer, having beneficial effect on the surrounding environment.

There have thus been described and illustrated certain embodiments of a method of improving the fire resistance of a cellulose material according to the invention. Although the present invention has been described and illustrated in detail, it should be clearly understood that the disclosure is illustrative only and is not to be taken as limiting, the spirit and scope of the invention being limited only by the terms of the appended claims and their legal equivalents.

What is claimed is:

1. A method of improving the fire resistance of a cellulose material comprising:
mixing a borate compound with an organic alcohol to form a borate ester;
combining the borate ester with a heated salt solution to form a borate compound;
treating the cellulose material with the borate compound; and
heating the treated cellulose material to evaporate remaining alcohol and solvent to form borate crystals within the cellulose material.

2. The method of improving the fire resistance of a cellulose material of claim 1 wherein the organic alcohol is selected from the group consisting of methanol, ethanol, 1-propanol, 2-propanol, glycerol, ethylene glycol, propylene glycol, isopropanol, polyethylene glycol, and combinations thereof.

3. The method of improving the fire resistance of a cellulose material of claim 1 wherein the borate compound is boric acid.

4. The method of improving the fire resistance of a cellulose material of claim 1 wherein the organic alcohol is methanol.

5. The method of improving the fire resistance of a cellulose material of claim 1 wherein the salt solution is selected from the group consisting of salts of magnesium, calcium, sodium, potassium, ammonium, aluminum, zinc, iron, and/or other cations, in conjunction with phosphate, carbonate, bicarbonate, silicate, sulfate, hydroxide, chloride, and nitrate, or any combination thereof.

6. The method of improving the fire resistance of a cellulose material of claim 1 wherein the salt solution is magnesium sulfate.

7. The method of improving the fire resistance of a cellulose material of claim 1 wherein the salt solution contains ammonium nitrate.

8. The method of improving the fire resistance of a cellulose material of claim 1 wherein the salt solution is heated before combining it with the borate ester.

9. The method of improving the fire resistance of a cellulose material of claim 1 wherein the salt solution is heated after combining it with the borate ester.

10. The method of improving the fire resistance of a cellulose material of claim 1 further comprising:
converting the borate compound into a low viscosity solution, and
treating the cellulose material with the borate solution.

11. The method of improving the fire resistance of a cellulose material of claim 10 wherein the liquid is water.

12. The method of improving the fire resistance of a cellulose material of claim 10 wherein the liquid is methanol.

13. The method of improving the fire resistance of a cellulose material of claim 10 wherein the liquid is selected from the group consisting of water, methanol and a mixture of water and alcohol.

14. The method of improving the fire resistance of a cellulose material of claim 10 wherein the cellulose material is wood, and treating the wood comprises applying the liquid borate compound to the cellulose material until reaching a weight of at least two percent.

15. The method of improving the fire resistance of a cellulose material of claim 14 wherein the wood is heated to a temperature between 50° F. and 120° F. before treatment with the liquid borate compound.

16. The method of improving the fire resistance of a cellulose material of claim 10 wherein the liquid is selected from the group consisting of water, methanol and a mixture of water and alcohol.

17. A method of improving the fire resistance of a cellulose material comprising:
mixing boric acid with methanol to form a boric acid ester;
combining the borate ester with a magnesium sulfate compound to form a magnesium borate sulfate solution;
treating the cellulose material with the magnesium borate sulfate solution; and
heating the treated cellulose material to evaporate remaining alcohol and solvent to form borate crystals within the cellulose material.
